(19) United States
(12) Patent Application Publication
(10) Pub. No.: US 2025/0200132 A1
(43) Pub. Date: Jun. 19, 2025

(54) DATA DEFRAGMENTATION TO REDUCE POWER CONSUMPTION

(71) Applicant: Dell Products L.P., Round Rock, TX (US)

(72) Inventors: Ramesh DODDAIAH, Westborough, MA (US); Daniel L. HAMLIN, Round Rock, TX (US); Ganesh KRISHNAMURTHY, Bangalore (IN); Malathi RAMAKRISHNAN, Madurai (IN)

(73) Assignee: Dell Products L.P., Round Rock, TX (US)

(21) Appl. No.: 18/538,522

(22) Filed: Dec. 13, 2023

(51) Int. Cl. G06F 17/15

(52) U.S. Cl. CPC G06F 17/15

(57) ABSTRACT

An information handling system may include at least one processor; a volatile memory; and a non-volatile memory. The information handling system may be configured to: determine pairwise correlations between data in a plurality of regions of the non-volatile memory; and destage data from the volatile memory to the non-volatile memory in accordance with the pairwise correlations, such that first data is destaged with second data having a high degree of correlation to the first data.

### TECHNICAL FIELD

The present disclosure relates in general to information handling systems, and more particularly to techniques for destaging data (e.g., flushing data from volatile memory such us DRAM to non-volatile memory such as a hard disk drive, a solid state drive, etc.) in a way that reduces power consumption.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In both HCI systems and non-HCI systems, it is often the case that data may be stored in volatile memory (e.g., cached in RAM) for a period of time prior to being destaged to non-volatile memory. In existing implementations, such data is destaged without regard to the data content or the disk locations that are being written. This causes repeated and unrelated write I/O operations, which can increase the amount of disk fragmentation, leading to future disk defragmentation work that requires a large amount of power.

Embodiments of this disclosure may operate by learning correlations between different elements of data, and destaging data at the same time (e.g., concurrently or sequentially) as data that is related. This may reduce the amount of defragmentation later required.

Techniques according to this disclosure may be particularly useful in edge devices in an edge computing scenario. However, it should be noted that while the edge deployment scenario is discussed in detail herein for the sake of concreteness, other embodiments are also specifically contemplated within the scope of this disclosure.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with data destaging may be reduced or eliminated.

In accordance with embodiments of the present disclosure, an information handling system may include at least one processor; a volatile memory; and a non-volatile memory. The information handling system may be configured to: determine pairwise correlations between data in a plurality of regions of the non-volatile memory; and destage data from the volatile memory to the non-volatile memory in accordance with the pairwise correlations, such that first data is destaged with second data having a high degree of correlation to the first data.

In accordance with these and other embodiments of the present disclosure, a method may include an information handling system determining pairwise correlations between data in a plurality of regions of a non-volatile memory; and the information handling system destaging data from a volatile memory to the non-volatile memory in accordance with the pairwise correlations, such that first data is destaged with second data having a high degree of correlation to the first data.

In accordance with these and other embodiments of the present disclosure, an article of manufacture may include a non-transitory, computer-readable medium having computer-executable instructions thereon that are executable by a processor of an information handling system for: determining pairwise correlations between data in a plurality of regions of a non-volatile memory; and destaging data from a volatile memory to the non-volatile memory in accordance with the pairwise correlations, such that first data is destaged with second data having a high degree of correlation to the first data.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a correlation matrix between extents of non-volatile memory, in accordance with embodiments of the present disclosure; and

FIG. 3 illustrates time-dependent correlations between extents of non-volatile memory.

### DETAILED DESCRIPTION

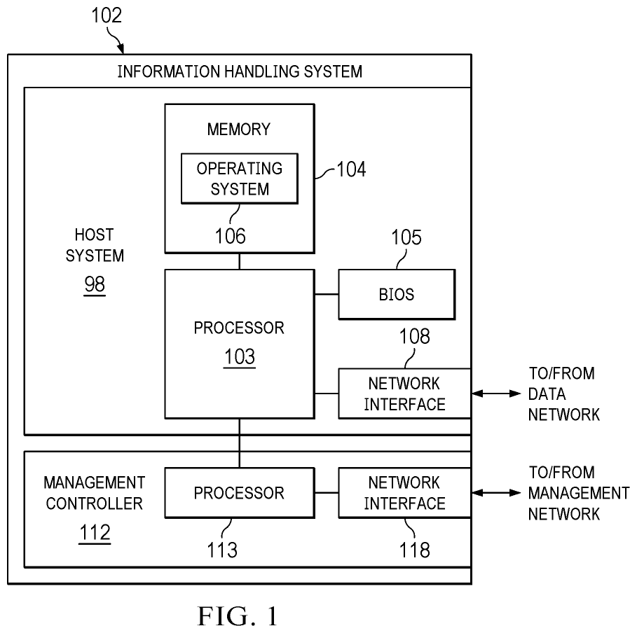

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide improvements in the destaging of data from volatile storage to non-volatile storage in information handling system 102. During operation of information handling system 102, data may at times reside in a volatile memory portion of memory 104 such as DRAM (e.g., in a cache), and may need to be written to non-volatile memory portion of memory 104 such as a hard disk drive, a solid state drive, NVRAM, etc. This process is referred to as destaging the data. By determining correlations between different portions of the data and destaging related data at the same time, disk fragmentation may be reduced.

For example, correlated data may be destaged simultaneously. In other embodiments, correlated data may be destaged in sequence (e.g., without any intervening uncorrelated destaging operations).

According to one embodiment, write I/O operations may initially be randomly assembled into groups to be destaged together. Over time, this random grouping may be improved upon by determining what percentage of I/O within a given disk region are being read and/or written together.

The term “region” may be used herein to refer to a disk extent of a given size (e.g., 1 GB in one implementation). Regions may be correlated within a single physical storage resource and/or across multiple physical storage resources.

For example, in a time window comprising the last S seconds, the system may determine the percentage of write destaging done across different regions of the storage devices, and a correlation matrix for the respective devices and regions may be built.

Over time, the correlation matrix may improve. The correlation matrix may be constructed as an N*N matrix, where N is the number of regions, and the entries of the matrix may reflect pairwise the degree of correlation between each region and all of the other regions.

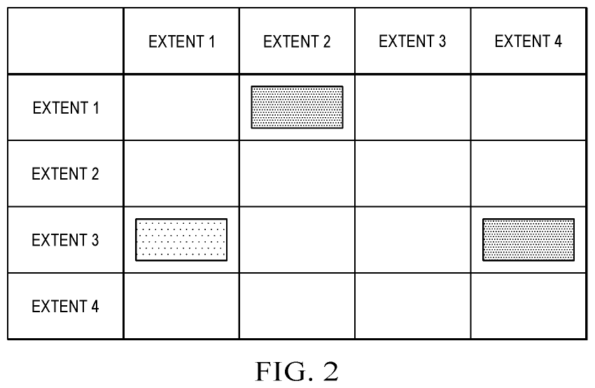

FIG. 2 provides an example of such a correlation matrix. As shown, extents 1 and 2 are highly correlated and should be destaged together. Extent 3 has a high correlation with extent 4, and a milder correlation with extent 1. (Each extent is 100% correlated with itself, and so those self-correlations are omitted from FIG. 2.)

After some time (e.g., days or weeks) passes, the matrix may provide a heat map that shows which regions are strongly correlated with one another, both within devices and across devices. Going forward, those regions that are highly correlated may be destaged together to reduce internal disk fragmentation, reducing power consumption of future defragmentation operations. For example, when multiple regions are to be destaged, the system may operate by first destaging the pair having the highest degree of correlation, next destaging the pair having the second highest degree of correlation, etc.

In one embodiment, the correlation map may be constructed to show which areas of disks are typically written in the same time window (e.g., an hour). As one example situation, consider data that includes multiple videos that were captured around the same time. Those videos might later end up being uploaded to the cloud at the same time and then deleted from local storage. Thus it would be advantageous to store them in a contiguous block of local disk space, so that deleting them creates one large unallocated chunk instead of many small unallocated chunks.

Embodiments may also take into account time-based variations in the correlations. For example, a correlation matrix such as the matrix in FIG. 2 may be constructed for each of a plurality of time windows, and the variations in those matrices may be examined to determine time series characteristics (e.g., over a period of days or months or years). In some embodiments, autoregressive integrated moving average (ARIMA) techniques may be used for these purposes.

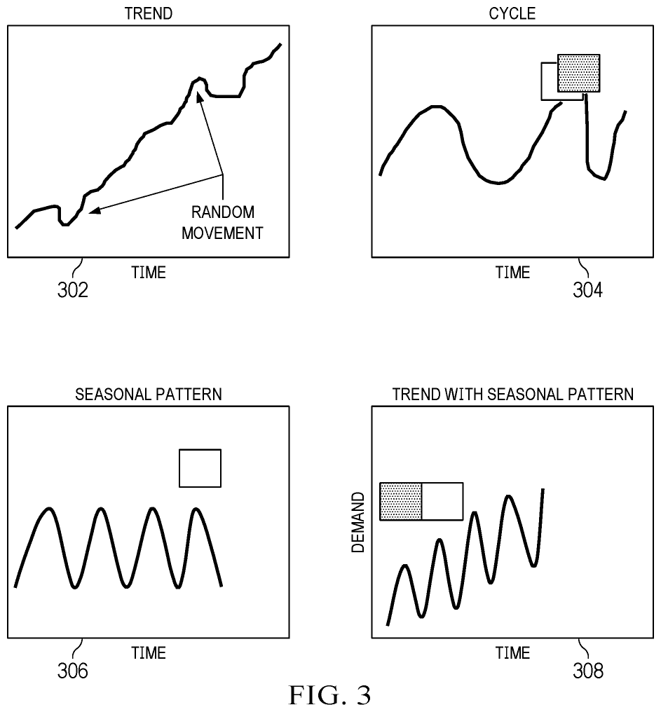

FIG. 3 illustrates certain time series components that may show up in the analysis of a plurality of correlation matrices. For example, graph 302 shows an overall upward trend in the degree of correlation between two regions (with some random variation as well). Graph 304 shows a cyclical variability. Similarly, graph 306 shows seasonal variations. Graph 308 shows an upward trend combined with seasonal variations.

Thus embodiments may establish time-dimension-aware correlations between extents to predict regions of non-volatile storage that are likely to have correlated data at a given time in the future. Those regions may then be destaged together in the future based on those predicted correlations. This may reduce the amount of disk defragmentation needed in the future, improving power consumption and other performance characteristics.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without t limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor;
a volatile memory; and
a non-volatile memory;
wherein the information handling system is configured to:
determine pairwise correlations between data in a plurality of regions of the non-volatile memory; and
destage data from the volatile memory to the non-volatile memory in accordance with the pairwise correlations, such that first data is destaged with second data having a high degree of correlation to the first data.

2. The information handling system of claim 1, wherein the information handling system is a hyper-converged infrastructure (HCI) system.

3. The information handling system of claim 1, wherein the first data is destaged simultaneously with the second data.

4. The information handling system of claim 1, wherein the first data is destaged sequentially with the second data, without any intervening destaging operations.

5. The information handling system of claim 1, wherein the information handling system is configured to predictively determine future pairwise correlations.

6. The information handling system of claim 5, wherein the future pairwise correlations are based on an autoregressive integrated moving average (ARIMA).

7. A method comprising:
an information handling system determining pairwise correlations between data in a plurality of regions of a non-volatile memory; and
the information handling system destaging data from a volatile memory to the non-volatile memory in accordance with the pairwise correlations, such that first data is destaged with second data having a high degree of correlation to the first data.

8. The method of claim 7, wherein the information handling system is a hyper-converged infrastructure (HCI) system.

9. The method of claim 7, wherein the first data is destaged simultaneously with the second data.

10. The method of claim 7, wherein the first data is destaged sequentially with the second data, without any intervening destaging operations.

11. The method of claim 7, further comprising predictively determining future pairwise correlations.

12. The method of claim 11, wherein the future pairwise correlations are based on an autoregressive integrated moving average (ARIMA).

13. An article of manufacture comprising a non-transitory, computer-readable medium having computer-executable instructions thereon that are executable by a processor of an information handling system for:
determining pairwise correlations between data in a plurality of regions of a non-volatile memory; and
destaging data from a volatile memory to the non-volatile memory in accordance with the pairwise correlations, such that first data is destaged with second data having a high degree of correlation to the first data.

14. The article of claim 13, wherein the information handling system is a hyper-converged infrastructure (HCI) system.

15. The article of claim 13, wherein the first data is destaged simultaneously with the second data.

16. The article of claim 13, wherein the first data is destaged sequentially with the second data, without any intervening destaging operations.

17. The article of claim 13, wherein the information handling system is configured to predictively determine future pairwise correlations.

18. The article of claim 17, wherein the future pairwise correlations are based on an autoregressive integrated moving average (ARIMA).
